(19) United States
(12) Patent Application Publication
(10) Pub. No.: US 2026/0267250 A1
(43) Pub. Date: Sep. 10, 2026

(54) AQUEOUS EMULSIONS CONTAINING A CHARGE CONTROL AGENT, TONER COMPOSITIONS PRODUCED THEREFROM, AND METHODS FOR PRODUCTION THEREOF

(71) Applicant: XEROX CORPORATION, Norwalk, CT (US)

(72) Inventors: Yu QI, Penfield, NY (US); Jing X. SUN, Lexington, KY (US); Jordan A. FRANK, Rochester, NY (US); Chieh-Min CHENG, Rochester, NY (US)

(73) Assignee: XEROX CORPORATION, Norwalk, CT (US)

(21) Appl. No.: 19/070,272

(22) Filed: Mar. 4, 2025

(51) Int. Cl. G03G 9/097; G03G 9/08; G03G 9/093

(52) U.S. Cl. CPC G03G 9/09708; G03G 9/0804; G03G 9/09328; G03G 9/09392

(57) ABSTRACT

Toner particles and toner compositions may be formed using a charge control agent that promotes positive triboelectric chargeability. Toner compositions may comprise: a plurality of toner particles comprising an anionic polymer, the toner particles comprising a core surrounded by a shell, and at least one charge control agent localized within the shell of the toner particles, the at least one charge control agent being positively chargeable.

### FIELD

The present disclosure relates generally to printing and, more particularly, to positively chargeable toner particles, toner compositions and methods for production thereof.

### BACKGROUND

In electrophotographic printing, an electrostatic image is latently formed by selectively discharging areas of a photoconductive drum. Toner particles that are triboelectrically charged then adhere to the electrostatic image through electrostatic attractions to produce a visible image. The visible image is then transferred from the photoconductive drum to a substrate such as paper. After transfer, the visible image is then fused to the paper by heating, during which the toner particles melt and bond with the substrate.

Toner particles, depending on their composition, may have a positive or negative charge when charged triboelectrically. Most commercial chemically prepared toner (CPT) compositions are produced by emulsion aggregation (EA) methods and are negatively chargeable due to their use of anionic polymers. Most commercial toners are negatively chargeable due to their reliance on established manufacturing processes and cartridge designs. Anionic polyester resins are commonly used in the production of negatively chargeable toners.

There is a growing demand for positively chargeable toner compositions, especially chemically prepared toner compositions, which may provide advantages in terms of particle size, particle shape, particle size distribution, and particle shape distribution, which may facilitate high-speed printing and good printing quality. This performance benefit is at least in part due to the durability, low-energy fusing, charge-up speed, charge value, and stability of positively chargeable toner compositions.

Despite their potential benefits, positively chargeable toner compositions may be difficult to manufacture through chemical production. One approach for producing positively chargeable toner compositions is to begin with different starting materials than those used to produce negatively chargeable toner compositions. This approach can be cost-prohibitive because of the different starting materials and potentially different production methods. For example, positively charged (cationic) polymers may fail to emulsify in the same manner as negatively charged polymers. Currently available positively chargeable CPTs are commonly formulated using styrene-acrylic resins, which often exhibit poorer printing performance compared to polyester resins, such as poorer charge-up speed, substrate fusion, stability, and glossiness, as well as higher fusion temperatures.

### SUMMARY

In some embodiments, the present disclosure provides aqueous emulsions comprising: a plurality of microparticles dispersed in an aqueous fluid, the microparticles comprising an anionic polymer; and at least one charge control agent located upon at least a portion of an outer surface of at least a portion of the microparticles, the at least one charge control agent being positively chargeable.

Methods for forming the aqueous emulsions may comprise: providing a combined emulsion comprising a plurality of microparticles dispersed in a continuous phase and at least one charge control agent dissolved in the continuous phase, the microparticles comprising an anionic polymer and the at least one charge control agent being positively chargeable; wherein the continuous phase comprises water and at least one water-miscible organic solvent; and removing at least a portion of the at least one water-miscible organic solvent from the combined emulsion to produce the aqueous emulsion.

In some embodiments, the present disclosure provides toner compositions comprising: a plurality of toner particles comprising an anionic polymer, the toner particles comprising a core surrounded by a shell; and at least one charge control agent localized within the shell of the toner particles, the at least one charge control agent being positively chargeable.

Methods for producing the toner particles and toner compositions may comprise: aggregating microparticles within a first aqueous emulsion below a glass transition temperature of the microparticles to form aggregated microparticles, the microparticles comprising an anionic polymer; contacting the aggregated microparticles with the aqueous emulsion of Embodiment 1 and then heating the aggregated microparticles above the glass transition temperature; maintaining the aggregated microparticles above the glass transition temperature until the aggregated microparticles have coalesced into molten microparticles having a desired shape and/or morphology; and once molten microparticles having the desired shape and/or morphology have formed, cooling the molten microparticles below the glass transition temperature to form toner particles comprising a core surrounded by a shell; wherein the at least one charge control agent is localized within the shell of the toner particles.

### BRIEF DESCRIPTION OF THE DRAWINGS

Not applicable.

### DETAILED DESCRIPTION

The present disclosure relates generally to printing and, more particularly, to positively chargeable toner particles, toner compositions and methods for production thereof.

As discussed above, most commercial toner compositions produced by emulsion aggregation (EA) methods are negatively chargeable toners, which frequently contain anionic polyester resins. Toner particles produced though emulsion aggregation methods may be referred to as “EA toners” or “EA toner compositions” herein. Although there is growing demand for positively chargeable toners, comparable production of positively chargeable toners by emulsion aggregation has proven difficult. For example, direct use of cationic polymers instead of anionic polymers during EA toner methods may disrupt the facile particle aggregation and coalescence processes that are characteristic of negatively chargeable toners. Without being bound by theory or mechanism, additional components used in toner production, such as wax and pigment dispersions, are stabilized with negative surfactants, which may be ineffective for emulsifying cationic polymers and may also contribute to negative chargeability.

The present disclosure provides positively chargeable toner particles and toner compositions and facile production methods thereof. More specifically, the present disclosure leverages current emulsion aggregation methods for producing negatively chargeable toner particles and toner compositions but adds a positively chargeable charge control agent and other additives to shift the overall particle chargeability from negative to positive. This approach may allow equipment, starting materials, and production methods used for producing negatively chargeable toners to be adapted for producing positively chargeable toners. Producing positively chargeable toner particles and toner compositions in this manner may allow for reduced costs compared to preparing positively chargeable toners from scratch with different starting materials and production methods. Surprisingly, altering the chargeability state of toner particles from negative to positive does not appreciably disrupt the EA processes utilized during toner production. At the least, the amount of charge control agent may be adjusted to achieve sufficient positive chargeability without disrupting the EA process to a significant degree.

The charge control agent may be located at any location within the toner particles. The location may be throughout the toner particles or localized in a portion of the toner particles. Surprisingly, a charge control agent need not necessarily be incorporated throughout the entirety of the polymer matrix defining the toner particles in order to induce positive chargeability. Instead, the charge control agent may be localized within a shell overlaying a core that otherwise lacks the charge control agent. When localized within the shell, the charge control agent is accessible and may promote ready triboelectric charging. In contrast, a charge control agent buried within the core is not readily triboelectrically chargeable. By localizing the charge control agent within the shell of toner particles, smaller amounts of charge control agent may be utilized to realize a comparable degree of triboelectric chargeability compared to incorporation of a greater amount of the charge control agent throughout the toner particles. Localization of the charge control agent within the shell may decrease raw material costs associated with toner production, lessen the likelihood of disrupting the process of toner particle formation, and aid in maintaining printing performance compared to that realized when higher amounts of the charge control agent are used.

To accomplish localization of the charge control agent within a shell of the toner particles, the present disclosure provides aqueous emulsions in which the charge control agent is immobilized upon the surface of polymer particles within the emulsion. The aqueous emulsions containing the charge control agent may be utilized during EA toner processes to form a shell upon aggregated polymer particles, typically lacking the charge control agent. Following coalescence of the core and shell, the shell may contain a highly localized concentration of the charge control agent, whereas the core lacks or substantially lacks the charge control agent. By immobilizing the charge control agent upon the surface of the polymer particles in an emulsion, the polymer particles may serve as a facile carrier for the charge control agent to allow localized incorporation of the charge control agent to take place, such as when forming core-shell toner particles. Various techniques for forming the aqueous emulsions containing the charge control agent are applicable and are discussed further herein.

In the present disclosure, “chargeable” refers to triboelectric chargeability, which occurs through static electricity charging. When referring to toner particles or toner compositions formed therefrom, triboelectric chargeability refers to the ability of the toner particles to obtain a charge when charged triboelectrically with static electricity and maintain the charge consistently during a printing process, during which the toner particles transfer and adhere to a print substrate under electrostatic forces. The terms “chargeable” and “chargeability” do not necessarily refer to the absolute charge of the toner particles or a polymer therein before triboelectric charging.

The present disclosure seeks to decrease the amount of negative charge in the toner particles through use of a suitable charge control agent in the shell of core-shell toner particles that allows a positive charge to be realized during triboelectric charging. Without being bound by theory, anionic functional groups of the anionic polymer within the toner particles may associate with the cationic portion of the charge control agent to neutralize at least a portion of the initial negative charge of the anionic polymer. All of the anionic functional groups in the anionic polymer need not necessarily have their negative charge neutralized by the cationic portion of the charge control agent. Thus, positively chargeable toner particles may still have an overall negative charge by virtue of an incompletely neutralized anionic polymer before triboelectric charging. More specifically, the shell of core-shell toner particles may still have an overall negative charge after association with the positive ion of a charge control agent but still be positively chargeable by triboelectric charging.

Glass transition temperature (T_{g}) is the temperature at which a polymer changes from a rigid state to a soft state. In the present disclosure, the glass transition temperature (T_{g}) may be determined by differential scanning calorimetry over a temperature range of 0° C. to 140° C. with a 10° C./minute ramping rate.

In the present disclosure, the term “D50” refers to a diameter at which 50% of a sample (on a volume basis unless otherwise specified) is comprised of particles having a diameter less than said diameter value. D50 represents the average particle size by volume. In the present disclosure, the term “D10” refers to a diameter at which 10% of a sample (on a volume basis unless otherwise specified) is comprised of particles having a diameter less than said diameter value. In the present disclosure, the term “D90” refers to a diameter at which 90% of a sample (on a volume basis unless otherwise specified) is comprised of particles having a diameter less than said diameter value. Particle size may be measured using a Beckman Coulter Multisizer 3, operated in accordance with the manufacturer's instructions.

In the present disclosure, the terms “diameter span,” “span,” and “span size,” when referring to a particle diameter, provides an indication of the breadth of the particle size distribution and is calculated as (D90-D10)/D50, as these quantities are defined above. The narrower the particle size distribution, the closer the span is to a value of 1.

In the present disclosure, the term “width” refers to the width of a particle size distribution curve at half of maximum peak height.

In the present disclosure, the term “circularity” refers to how close a toner particle is to a perfect sphere. To determine circularity, optical microscopy images are taken of a toner particle. The perimeter and area of the particle in the plane of the microscopy image is calculated (e.g., using a SYSMEX FPIA 3000 particle shape and particle size analyzer, available from Malvern Instruments). The circularity of the toner particle is C_{EA}/P, where C_{EA} is the circumference of a circle having the area equivalent to the area of the actual particle. The more spherical the toner particles are, the closer the circularity is to a value of 1.

Compositions comprising toner particles are described herein. The compositions comprise core-shell toner particles, which comprise a core surrounded by a shell. More specifically, the compositions comprise toner particles comprising an anionic polymer, and at least one charge control agent localized within the shell of the toner particles, wherein the at least one charge control agent is positively chargeable. Overall, the toner particles and toner compositions resulting therefrom may be positively chargeable, as assessed by triboelectric chargeability. The at least one charge control agent comprises a cationic portion and an anionic portion, in which the cationic portion forms an ionic association with at least a portion of the negatively charged functional groups and reduces an overall negative charge of the polymer.

Suitable polymers for forming the toner particles may include but are not limited to polyacrylates, polyesters, polystyrenes, any copolymer thereof, and any combination thereof. Suitable polyesters may be linear, branched, or combinations thereof. Illustrative polyesters that may be suitable include those described in U.S. Pat. Nos. 11,092,906 and 8,383,311, the disclosures of which are incorporated by reference in their entirety. In some embodiments, the polymer may comprise an anionic polyester.

The toner particles may comprise one or more anionic polymers, which may be linear, branched, or any combination thereof. The one or more anionic polymers may comprise a plurality of negatively charged functional groups, including, but not limited to, carboxylates or sulfonates. The negatively charged functional groups may be present within the main polymer chain or be present within a side chain of the anionic polymer. Optionally, a co-monomer bearing the anionic functional groups may be reacted with one or more other monomers that are otherwise uncharged. Optionally, additional anionic functional groups may be introduced through carboxylation or sulfonation of an otherwise unfunctionalized polymer. Illustrative anionic polymers that may be suitable for use in the present disclosure include, but are not limited to, anionic polyesters. Examples of polyester-based toners that may be modified according to the disclosure herein include those described in U.S. Pat. Nos. 11,092,906 and 8,383,311, the disclosures of which are incorporated by reference above.

Suitable anionic polyesters for inclusion in the toner particles may include amorphous polyesters, crystalline polyesters, or any combination thereof. In some examples, an anionic polyester may be present in combination another polymer, such as a styrene-acrylate.

When amorphous polyesters and crystalline polyesters are used in combination with one another, the amorphous polyester and the crystalline polyester may be present over a wide composition range. In non-limiting examples, the ratio of crystalline polyester to amorphous polyester may range from about 1:99 to about 99:1 on a mass basis or about 1:9 to about 9:1 on a mass basis. For example, the amorphous polyester may range from about 60 wt % to about 80 wt %, based on total polymer in the toner particles, and the crystalline polyester may range from about 20 wt % to about 40 wt %, based on total polymer in the toner particles. A single amorphous polyester or multiple amorphous polyesters may be present. Likewise, a single crystalline polyester or multiple crystalline polyesters may be present.

Polyesters may be formed as a polymerized reaction product of a diol and a dicarboxylic acid or dicarboxylic acid derivative (e.g., an ester of a dicarboxylic, an anhydride of a dicarboxylic acid, or a diacid chloride). Depending on whether an amorphous polyester or a crystalline polyester is desired, the diol and the dicarboxylic acid or dicarboxylic acid derivative may be selected accordingly.

Examples of diacids or diesters suitable for forming amorphous polyesters may include, but are not limited to, terephthalic acid, phthalic acid, isophthalic acid, fumaric acid, trimellitic acid, dimethyl fumarate, dimethyl itaconate, cis-1,4-diacetoxy-2-butene, diethyl fumarate, diethyl maleate, maleic acid, succinic acid, itaconic acid, succinic acid, succinic anhydride, dodecylsuccinic acid, dodecenylsuccinic acid, dodecylsuccinic anhydride, dodecenylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and any combination thereof. Anhydrides of any of the foregoing carboxylic acids may also be used.

Examples of diols suitable for forming amorphous polyesters may include, but are not limited to, 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, propoxylated bisphenol A, ethoxylated bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene glycol, and any combination thereof.

In some examples a suitable amorphous polyester may comprise poly(propoxylated bisphenol A-co-fumarate), such as that described in U.S. Pat. No. 6,063,827, which is incorporated herein by reference. Other examples of suitable amorphous polyesters may include, for instance, a copolymerized reaction product of propoxylated bisphenol A, ethoxylated bisphenol A, terephthalic acid, fumaric acid, and dodecenyl succinic anhydride (e.g., poly(propoxylated (ethoxylated) bisphenol A-co-terephthlate-fumarate-dodecenylsuccinate) or a copolymerized reaction product of propoxylated bisphenol A, ethoxylated bisphenol A, terephthalic acid, trimellitic acid, and dodecenyl succinic anhydride.

Examples of diacids or diesters suitable for forming crystalline polyesters may include, but are not limited to, oxalic acid, succinic acid, glutaric acid, adipic acid, suberic acid, azelaic acid, sebacic acid, fumaric acid, dimethyl fumarate, dimethyl itaconate, cis-1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid, and mesaconic acid. Anhydrides of any of the foregoing carboxylic acids may also be used.

Examples of diols suitable for forming crystalline polyesters may include, but are not limited to, C₂ to C₃₆ diols, preferably terminal diols, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol, or any combination thereof.

In some examples a suitable crystalline polyester may comprise a polymerized reaction product of dodecanedioic acid and 1,9-nonanediol.

The core and the shell of the toner particles may comprise the same anionic polymer(s) or different anionic polymer(s). In some examples, the core and the shell may comprise the same anionic polymer. The core and the shell may comprise a crystalline polyester or an amorphous polyester. Optionally, the core and/or the shell may comprise the combination of a crystalline polyester and an amorphous polyester.

In some embodiments, an amorphous polyester may be present in at least the shell. In some embodiments, the shell may comprise a first amorphous polyester and a second amorphous polyester, which may be present in equal amounts or non-equal amounts. In some embodiments, at least a crystalline polyester may be present in the core.

The at least one charge control agent may be present within the polymer and toner particles obtained therefrom in an amount ranging from about 0.01 wt % to about 5 wt %, or about 0.1 wt % to about 3 wt %, or about 0.5 wt % to about 2.5 wt %, or about 0.5 wt % to about 2 wt %, or about 0.5 wt % to about 1 wt %, including all values and subranges in between, based on total mass of the polymer. The measured amount of the at least one charge control agent refers to the measured amount of the cationic portion of the at least one charge control agent that remains after isolation of the toner particles has taken place.

Within the shell, the at least one charge control agent may be present in an amount ranging from about 0.1 wt % to about 10 wt %, or about 1 wt % to about 8 wt %, or about 2 wt % to about 5 wt %, based on total mass of the shell.

Any charge control agent that is positively chargeable and does not interfere with the processes for making the toner particles may be utilized in the disclosure herein. Preferably, the at least one charge control agent may comprise a quaternary ammonium salt. In some examples, such charge control agents may comprise a quaternary ammonium cation and a sulfonate anion. Quaternary ammonium hydroxynaphthalene sulfonates may be particularly suitable charge control agents, for example. In more specific examples, the at least one charge control agent may comprise benzyltributylammonium hydroxynaphthalenesulfonate, which is available commercially as BONTRON-P51 (Orient Corporation). The relatively high water solubility of the sulfonate anion may allow the sulfonate anion to be readily removed by washing once the quaternary ammonium cation has neutralized at least a portion of the charge of the anionic polymer or other negative charged component (e.g., an anionic surfactant) within a toner composition.

Other non-limiting examples of suitable positively chargeable charge control agents may include, for example, distearyldimethyl ammonium methyl sulfate, distearyl dimethyl ammonium bisulfate. 4-aza-1-azoniabicyclo (2.2.2) octane salts, pyridinium salts, azines such as BONTRON N-series charge control agents or NIGROSINE charge control agents (Orient Corporation), polyamines, imidazoles, pyridines, and the like.

The cationic portion of the charge control agent may form an ionic association with the anionic functional groups of the anionic polymer or other component, thereby reducing an overall negative charge upon the polymer. After interacting with the charge control agent, the anionic polymer and toner particles obtained therefrom may be positively chargeable when charged triboelectrically. The overall triboelectric charge may be further shifted to positive using positively charged internal or external additives such as, for example, positively charged surfactants, positively charged metal oxides, and charge additives, illustrative examples of which are provided hereinbelow.

The toner particles of the present disclosure may be of any suitable shape, size, and morphology. For example, the toner particles may have a circularity, as determined by particle imaging, of about 0.96 to 1.0 or about 0.98 to about 1.0, including all values and subranges in between, such as about 0.97 to about 0.98 or about 0.98 to about 0.99. Preferably, the toner particles may have a D50 of about 5 microns to about 8 microns, including all values and subranges in between, such as about 6 microns to about 7 microns.

Toner particles containing at least one charge control agent within the shell may further comprise internal additives, external additives, or any combination thereof. Internal additives may be blended within the toner particles and are introduced during formation of the toner particles (e.g., during an EA toner process). Because internal additives are buried within the toner particles, they are believed to exert limited influence upon triboelectric chargeability. External additives, in contrast, may be blended with the toner particles after formation or isolation thereof, such that the external additives are located on the exterior (outer surface) of the toner particles or in the interstitial space between toner particles. Because external additives are outside the toner particles, they may exert a greater influence on triboelectric chargeability of finished toner compositions than do internal additives, such as colorants or other components. Internal or external additives that may be present include, but are not limited to, surfactants, colorants, waxes, charge additives, crosslinking agents and other common materials present in EA toner particles. One having ordinary skill in the art will recognize illustrative types of such additives and suitable amounts to include during or after production of toner particles by an EA toner process.

One or more surfactants may be present in an emulsion used to form toner particles, such that the one or more surfactants become an internal additive in the toner particles after aggregation and coalescence takes place. Such surfactants may also be combined with the toner particles when forming a toner composition, in which case the one or more surfactants may be present as an external additive. Suitable surfactants may be nonionic, zwitterionic, anionic, or cationic. If the surfactant is ionic, the surfactant may be used to contribute to the overall charge of the toner composition. For example, a cationic surfactant may contribute to positive chargeability, and an anionic surfactant may decrease positive chargeability. When an anionic surfactant is present, the at least one charge control agent may counterbalance the negative chargeability promoted by the anionic surfactant.

One or more colorants, including dyes and pigments, may be present when forming toner particles, such that the one or more colorants become internal additives within the toner particles. Colorants may comprise a single colorant or two or more colorants. Suitable colorants may be present in the toner particles in an amount of about 0.1 wt % to about 35 wt %, or about 1 wt % to about 15 wt %, or about 3 wt % to about 10 wt %, based on total mass of the toner particles. Suitable colorants may include yellow colorants, magenta colorants, cyan colorants, black colorants, or any combination thereof and may selected accordingly by persons having ordinary skill in the art.

One or more waxes may be present during formation of the toner particles, such that the one or more waxes are present as an internal additive. A single wax or two or more waxes may be present. When present, the one or more waxes may adjust characteristics of the toner particles, such as shape, size, surface area, charging and/or fusing characteristics, gloss, stripping, offset properties, the like, or combinations thereof. The one or more waxes may be obtained or formulated as aqueous emulsions or dispersions of solid wax in water having a wax particle size in the range of about 100 nm to about 300 nm. The one or more waxes may be present in an amount ranging from about 1 wt % to about 20 wt %, including all values and subranges in between, based on total mass of the toner particles. Suitable waxes and amounts thereof will be familiar to one having ordinary skill in the art and may be selected accordingly.

One or more external additives may also be included in the toner compositions formed from the toner particles described herein. Suitable external additives may include, for example, flow aids, charge additives, and the like. Examples of the foregoing will be familiar to persons having ordinary skill in the art. Like internal additives, charged external additives may increase or decrease the triboelectric chargeability. When present, external additives may be present in an amount of about 0.1 wt % to about 10 wt %, including all values and subranges in between, based on total mass of a toner composition formed from the toner particles.

Suitable flow aids may include silica, titania, or other metal oxides, silicates, metal oxides stearates, or any combination thereof. Silica (or titania) may include negatively charged silica (or titania) or positively charged silica (or titania), optionally with a hydrophobic or hydrophilic modification. Suitable examples of positive charged silica (or titania) may include, for example, amine-functionalized silica (or titania).

The toner particles described herein may be produced by EA toner production processes. To promote effective localization of the charge control agent in a shell of the toner particles, the EA toner production processes may utilize an aqueous emulsion containing the at least one charge control agent associated with anionic polymer particles within the emulsion.

Such aqueous emulsions for use in conjunction with EA toner production processes may comprise a plurality of microparticles comprising an anionic polymer dispersed in an aqueous fluid, and at least one charge control agent located upon at least a portion of an outer surface of at least a portion of the microparticles, wherein the at least one charge control agent is positively chargeable. Suitable anionic polymers and charge control agents include those specified above. Various techniques may be utilized for forming the aqueous emulsions, as described further below.

The anionic polymer and the at least one charge control agents may be present over a range of concentrations in the aqueous emulsions used to form the shell of the toner particles described herein. In non-limiting examples, a loading of the anionic polymer within the aqueous emulsions may range from about 1 wt % to about 50 wt %, based on total solids within the emulsion, including all weight % values and subranges in between, such as about 2 wt % to about 45 wt %, or about 5 wt % to about 35 wt %, or about 10 wt % to about 25 wt %, or about 20 wt % to about 45 wt %, or about 25 wt % to about 40 wt %. The loading of the at least one charge control agent within the aqueous emulsions may range from about 0.01 wt % to about 5 wt %, or about 0.1 wt % to about 3 wt %, or about 0.5 wt % to about 2.5 wt %, including all values and subranges in between, based on total solids within the emulsion.

Advantageously, the foregoing aqueous emulsions used for forming the shell of core-shell toner particles may be produced in a manner such that the at least one charge control agent is localized upon the outer surface of the microparticles (polymer microparticles) within the aqueous emulsion, rather than being dispersed in the continuous phase of the emulsion. By localizing the at least one charge control agent upon the outer surface of the microparticles, the at least one charge control agent may be more effectively incorporated within the shell of the resulting toner particles during formation thereof, such as during an EA toner production process.

Methods for forming an aqueous emulsion comprising at least one charge control agent upon a surface of microparticles may comprise: providing a combined emulsion comprising a plurality of microparticles dispersed in a continuous phase and at least one charge control agent dissolved in the continuous phase, in which the microparticles comprise an anionic polymer and the continuous phase comprises water and at least one water-miscible organic solvent; and removing at least a portion of the at least one water-miscible organic solvent from the combined emulsion to produce the aqueous emulsion comprising the at least one charge control agent located upon the outer surface of at least a portion of the microparticles.

Several techniques may be suitable for forming aqueous emulsions containing microparticles with a charge control agent thereupon.

In some examples, the aqueous emulsions may be formed starting with both the anionic polymer and the at least one charge control agent in a dissolved state, followed by forming the combined emulsion. In such cases, providing the combined emulsion may comprise: dissolving the anionic polymer in a first organic solvent to form a first solution; dissolving the at least one charge control agent in the water-miscible organic solvent to form a second solution; combining the first solution and the second solution to form a combined solution; and homogenizing the combined solution with a base to produce the combined emulsion. Alternately, either the first solution or the second solution may be obtained with the anionic polymer or the at least one charge control agent already dissolved before combining the first solution and the second solution to form the combined solution.

In other examples, the anionic polymer may be obtained in a previously emulsified form, which is then combined with a solution of the at least one charge control agent in the water-miscible organic solvent. The previously emulsified form may be obtained commercially or produced during a suitable emulsion polymerization. In such cases, providing the combined emulsion may comprise: providing a precursor aqueous emulsion comprising the plurality of microparticles comprising the anionic polymer dispersed in an aqueous phase; and combining the precursor emulsion with a solution comprising the at least one charge control agent dissolved in the water-miscible organic solvent to produce the combined emulsion.

If used, the organic solvent for dissolving the anionic polymer and the water-miscible organic solvent for dissolving the at least one charge control agent may be the same or different. The amount of the water-miscible organic solvent used may be just enough to dissolve the at least one charge control agent. Thus, if used, the organic solvent for dissolving the anionic polymer may be present in a greater amount than the water-miscible organic solvent for dissolving the at least one charge control agent.

Suitable water-miscible organic solvents are not believed to be particularly limited, provided they dissolve the at least one charge control agent, are acceptably removed from the combined emulsion, and do not undesirably impact the stability of the combined emulsion. Examples of suitable water-miscible organic solvents include, but are not limited to, C1-C4 monohydric alcohols (e.g., methanol, ethanol, isopropanol, and the like), alkylene glycols (e.g., ethylene glycol or propylene glycol), glycol ethers, acetone, and the like.

The organic solvent for dissolving the anionic polymer (if used) may be miscible with the water-miscible organic solvent when forming the combined solution. While the organic solvent may be miscible with the water-miscible organic solvent, the organic solvent need not necessarily be miscible with water itself. If present, the organic solvent for dissolving the anionic polymer may be removed in conjunction with the water-miscible organic solvent when forming the aqueous emulsion containing microparticles coated with at least one charge control agent. The organic solvent may be removed before, during, and/or after the water-miscible organic solvent. In non-limiting examples, the organic solvent for dissolving the anionic polymer may comprise methyl ethyl ketone. Other examples of suitable organic solvents for dissolving the anionic polymer may include, for instance, acetone, 2-butanone, pentanone, ethyl acetate, tetrahydrofuran, acetonitrile, diethyl ether, diethylene glycol, diglyme, 1,2-dimethoxyethane, DMF, DMSO, 1,4-dioxane, methyl tert-butyl ether, triethanolamine, ethanol, methanol, 1-propanol, 2-propanol and any combination thereof. In non-limiting examples, the at least one water-miscible organic solvent (and the organic solvent, if present) may be removed by distillation from the combined emulsion to form the aqueous emulsion. Distillation may be conducted by heating the combined emulsion above the boiling point of the at least one water-miscible organic solvent (and the organic solvent, if present) at a specified pressure, such as atmospheric pressure. Optionally, distillation of the at least one water-miscible organic solvent (and the organic solvent, if present) may take place at a sub-atmospheric pressure (e.g., any pressure below 1 atmosphere), such that removal of the at least one water-miscible organic solvent (and the organic solvent, if present) may take place at a lower temperature than at atmospheric pressure.

The above-described aqueous emulsions may be utilized in EA toner processes to produce a shell upon toner particles. Emulsion aggregation methods may take place by aggregating polymer particles contained within the continuous phase of an emulsion, optionally in the presence of other components (e.g., wax and/or colorants) that may become internal additives within the resulting toner particles. A second emulsion may be utilized prior to coalescence to form a shell upon the aggregated polymer particles that become the core of core-shell toner particles.

The emulsion aggregation methods described hereinbelow are intended to be illustrative in nature, and one having ordinary skill in the art may suitably modify other toner production techniques to realize the benefits described herein. Examples of emulsion-aggregation toner particle production methods that may be suitable to form toner particles for use herein may include, for instance, those described in U.S. Pat. Nos. 5,364,729, 5,496,676, 5,501,935, 5,919,595, 6,132,924, 6,495,302, 6,268,102, 6,500,597, 6,416,920, and 8,383,311, the disclosures of each of which are hereby incorporated by reference in their entirety.

Such methods may comprise: aggregating microparticles comprising an anionic polymer within a first aqueous emulsion below a glass transition temperature of the microparticles to form aggregated microparticles; contacting the aggregated microparticles with the aqueous emulsion containing at least one charge control agent, as described above, and then heating the aggregated microparticles above the glass transition temperature; maintaining the aggregated microparticles above the glass transition temperature until the aggregated microparticles have coalesced into molten microparticles having a desired shape and/or morphology; and once molten microparticles having the desired shape and/or morphology have formed, cooling the molten microparticles below the glass transition temperature to form toner particles comprising a core surrounded by a shell, in which the at least one charge control agent is localized within the shell of the toner particles.

During aggregation of the microparticles, an aggregating agent may be present to promote aggregation. Suitable aggregating agents may include, but are not limited to, polyaluminum chloride (PAC), polyaluminum silicates such as polyaluminum sulfosilicate (PASS), or a water-soluble salts such as aluminum chloride, aluminum nitrite, aluminum sulfate, potassium aluminum sulfate, calcium acetate, calcium chloride, calcium nitrite, calcium oxalate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, or combinations thereof. When used, the aggregating agent may be combined with the emulsion below the glass transition temperature of the polymer.

When used, the aggregating agent may be combined with the polymer particles in any effective amount up to about 5 wt %, based on a mass of the polymer particles, such as about 0.2 wt % to about 1 wt % or about 0.5 wt % to about 1.5 wt %.

The microparticles may be permitted to aggregate until a predetermined desired particle size is obtained. The particle size may be monitored during the growth process until the predetermined desired particle size is reached. The predetermined desired particle size refers to a target particle size to be obtained during aggregation, such that toner particles having a desired particle size are eventually obtained after coalescence is complete. The particle size is monitored during the growth process until the predetermined desired particle size is reached. Monitoring may take place using any of the particle size measurement techniques discussed herein. For example, samples may be taken during the growth process and analyzed, such as with a Coulter Counter, to determine the average particle size.

Depending on the glass transition temperature, aggregation may proceed at temperatures ranging from about 30° C. to about 100° C., or about 30° C. to about 80° C., or about 30° C. to about 50° C. The temperature may be held for a period of time from about 0.5 hours to about 6 hours, or about 1 hour to about 5 hours, during which time a desired aggregate size may form. Once a pre-determined aggregate size is reached, a shell resin may be added via the aqueous emulsion described above, and additional monitoring of the particle size may take place. Before adding the shell resin, the particle size may range from about 1 μm to about 6 μm, including all values and subranges in between. The shell may be formed upon the aggregated microparticles at the same temperature or a different temperature than that used for initially aggregating the microparticles, again with the temperature being below the glass transition temperature. Formation of the shell may take place for a period of time from about 30 minutes to about 5 hours or about 1 hour to about 5 hours.

Once a desired size of the aggregated microparticles and shell is achieved, the pH may be adjusted to a value of about 7.1 to about 10. Adjustment of the pH may be utilized to freeze (stop) toner particle growth. The base utilized to stop particle growth may include an alkali metal hydroxide, ammonium hydroxide, or any combination thereof, for example. A chelating agent such as ethylenediamine tetraacetic acid (EDTA), for example, may also be added to help adjust the pH to the desired value.

After applying the shell and freezing growth, the aggregated microparticles may then be coalesced to a desired final shape and circularity by heating above the glass transition, such as at a temperature of about 70° C. to about 100° C., or about 80° C. to about 95° C., or about 90° C. to about 99° C. Heating may continue or the pH of the mixture may be adjusted (e.g., reduced) over a period of time until a desired circularity is reached. The period of time may range from about 1 hour to about 10 hours or from about 2 hours to about 4 hours. Various buffers may be used during coalescence. Following coalescence, the circularity may be about 0.95 or greater, or about 0.96 or greater, or about 0.97 or greater, or about 0.98 or greater, or about 0.99 or greater.

Optionally, an acid or acid-generating compound may be added to increase the rate of coalescence. Illustrative examples of suitable acids or acid-generating compounds may include acetic acid, nitric acid, ammonium persulfate, or the like. If an acid or acid-generating compound is added, the pH may remain at an alkaline pH value or reach neutrality. Ammonium persulfate may be particularly desirable, since this chemical may decompose at the temperatures used to promote coalescence, and release protons gradually to lower the pH.

After coalescence is complete, cooling below the glass transition temperature may take place for isolation of the toner particles. A suitable cooling process may include introducing cold water to a jacket around the reactor, for example. After cooling, the toner particles may be screened with a sieve of a desired size, filtered, washed with water, and then dried. Washing may remove all or a substantial portion of the anionic portion of the at least one charge control agent from the toner particles, while the cationic portion remains in ionic association with at least a portion of the negatively charged functional groups, again with at least one charge control agent remaining localized within the shell of the toner particles. Drying may be accomplished by any suitable process for drying including, for example, freeze-drying.

Embodiments disclosed herein include:

Embodiment 1. An aqueous emulsion comprising:
a plurality of microparticles dispersed in an aqueous fluid, the microparticles comprising an anionic polymer; and
at least one charge control agent located upon at least a portion of an outer surface of at least a portion of the microparticles, the at least one charge control agent being positively chargeable.

Embodiment 2. The aqueous emulsion of Embodiment 1, wherein the at least one charge control agent comprises a quaternary ammonium cation and a sulfonate anion.

Embodiment 3. The aqueous emulsion of Embodiment 1 or Embodiment 2, wherein the anionic polymer comprises an anionic polyester.

Embodiment 4. A method comprising:
providing a combined emulsion comprising a plurality of microparticles dispersed in a continuous phase and at least one charge control agent dissolved in the continuous phase, the microparticles comprising an anionic polymer and the at least one charge control agent being positively chargeable;
wherein the continuous phase comprises water and at least one water-miscible organic solvent; and
removing at least a portion of the at least one water-miscible organic solvent from the combined emulsion to produce the aqueous emulsion of Embodiment 1.

Embodiment 5. The method of Embodiment 4, wherein the at least one charge control agent comprises a quaternary ammonium cation and a sulfonate anion.

Embodiment 6. The method of Embodiment 4 or Embodiment 5, wherein the anionic polymer comprises an anionic polyester.

Embodiment 7. The method of any one of Embodiments 4-6, wherein providing the combined emulsion comprises:
dissolving the anionic polymer in a first organic solvent to form a first solution;
dissolving the at least one charge control agent in the water-miscible organic solvent to form a second solution;
combining the first solution and the second solution to form a combined solution; and
homogenizing the combined solution with a base to produce the combined emulsion.

Embodiment 8. The method of Embodiment 7, wherein the first organic solvent comprises methyl ethyl ketone.

Embodiment 9. The method of Embodiment 7 or Embodiment 8, wherein the first organic solvent is also removed before, during, and/or after removing the at least one water-miscible organic solvent.

Embodiment 10. The method of any one of Embodiments 4-6, wherein providing the combined emulsion comprises:
providing a precursor aqueous emulsion comprising the plurality of microparticles dispersed in an aqueous phase; and
combining the precursor emulsion with a solution comprising the at least one charge control agent dissolved in the water-miscible organic solvent to produce the combined emulsion.

Embodiment 11. The method of any one of Embodiments 4-10, wherein the at least one water-miscible organic solvent is removed by distillation.

Embodiment 12. The method of any one of Embodiments 4-11, wherein the at least one water-miscible organic solvent is removed at a sub-atmospheric pressure.

Embodiment 13. A composition comprising:
a plurality of toner particles comprising an anionic polymer, the toner particles comprising a core surrounded by a shell; and
at least one charge control agent localized within the shell of the toner particles, the at least one charge control agent being positively chargeable.

Embodiment 14. The composition of Embodiment 13, wherein the at least one charge control agent comprises a quaternary ammonium cation and a sulfonate anion.

Embodiment 15. The composition of Embodiment 13 or Embodiment 14, wherein the anionic polymer comprises an anionic polyester.

Embodiment 16. The composition of any one of Embodiments 13-15, further comprising:
one or more internal additives located within the toner particles.

Embodiment 17. The composition of any one of Embodiments 13-16, further comprising:
one or more external additives.

Embodiment 18. A method comprising:
aggregating microparticles within a first aqueous emulsion below a glass transition temperature of the microparticles to form aggregated microparticles, the microparticles comprising an anionic polymer;
contacting the aggregated microparticles with the aqueous emulsion of Embodiment 1 and then heating the aggregated microparticles above the glass transition temperature;
maintaining the aggregated microparticles above the glass transition temperature until the aggregated microparticles have coalesced into molten microparticles having a desired shape and/or morphology; and
once molten microparticles having the desired shape and/or morphology have formed, cooling the molten microparticles below the glass transition temperature to form toner particles comprising a core surrounded by a shell;
wherein the at least one charge control agent is localized within the shell of the toner particles.

Embodiment 19. The method of Embodiment 19, wherein the at least one charge control agent comprises a quaternary ammonium cation and a sulfonate anion.

Embodiment 20. The method of Embodiment 19 or Embodiment 20, wherein the anionic polymer comprises an anionic polyester.

To facilitate a better understanding of the embodiments of the present disclosure, the following examples of preferred or representative embodiments are given. In no way should the following examples be read to limit, or to define, the scope of the disclosure.

### Examples

D50 by volume was characterized using a Coulter Multisizer-3 instrument. Circularity was determined using an FPIA Sysmex3000 instrument. Glass transition temperature (T_{g}) and other thermal properties were determined employing differential scanning calorimetry (DSC) over a temperature range of 0-140° C. with a 10° C./minute ramping rate during heating and cooling. The glass transition temperature was measured using a TA Instruments® Q2000, using a 10 mg sample of toner.

Triboelectric charge was measured with a specially constructed blow-off type Faraday cage. A steel carrier consisting of irregularly shaped particles, with a weight median diameter of 120-160 μm (sieve screen method), was used. Known quantities of carrier and toner particles were used to provide a toner concentration of about 3 pph. The carrier and toner particles were weighed into a 120 mL glass jar. The jar was shaken for 10 minutes on a paint shaker at a frequency of 615 min⁻¹. Charging results from an interaction of the two types of particles. A known weight of tribocharged developer was poured into the Faraday cage. When the charged toner is blown out of the cage, the cage becomes oppositely charged. The net charge on the cage at the end of this process was measured with an electrometer (Keithley 614), and the charge-to-mass ratio was calculated and reported as μc/g (microcoluombs per gram).

In the tables below, “tribo” means triboelectric charge.

The amount of charge control agent incorporated within the toner particles was measured by LC-MS. To perform the LC-MS analysis, about 0.1 g toner particles were accurately weighed and combined with 5 mL of chloroform, followed by shaking for 1 hour. Methanol (15 mL) was then added. The samples were shaken for 30 minutes, and filtered through a 0.2 μm nylon filter. The filtrate was diluted 10-fold or 100-fold in methanol. The diluted filtrate solutions were processed on a 4.6×50 mm ZIRCHROM-PHASE 5 μm column at 400 μL/min using an isocratic mobile phase of 10% 10 mM ammonium acetate, 0.1% acetic acid in 3% acetonitrile and 90% 10 mM ammonium acetate, and 0.1% acetic acid in 50:50 acetonitrile: methanol on an ACCELA HIGH SPEED LC system interfaced to the Q-EXACTIVE mass spectrometer. Data were collected using positive and negative mode electrospray ionization (ESI) techniques. The positive ion at m/z 276.2679 was fragmented, and peak area of the resulting fragment ion at m/z 142.15 to 142.17 was used to determine the amount of positive ion of the charge control agent. For the negative ion of the charge control agent, the ion does not fragment significantly. Therefore, the area of the negative ion peak at m/z 222.990 to 223.02 was used to determine the amount of the negative ion of charge control agent. A methanol stock solution of benzyltributylammonium naphthalenesulfonate was used for calibration over a range of 0.01 to 2 μg/m.

### Example 1: Aqueous Emulsion Synthesis by Co-Dissolution of Anionic Polyester

and Charge Control Agent. An amorphous anionic polyester was dissolved in methyl ethyl ketone by heating at about 50° C. Benzyltributylammonium naphthalenesulfonate (charge control agent) was dissolved in a minimal amount of ethanol and combined with the solution of the anionic polyester. The resulting combined solution mixed with an aqueous NaOH solution under high-shear mixing to produce an emulsion still containing the organic solvents. The organic solvents were removed through vacuum distillation to produce the final aqueous emulsion.

Table 1A shows the amounts of components used in forming the final aqueous emulsions obtained under various co-dissolution conditions. In Tables 1A and 1B, resin refers to the anionic polyester, MEK is methyl ethyl ketone, CCA is the charge control agent, and EtOH is ethanol. Table 1B shows particle size distribution and other data of the final aqueous emulsions obtained under the various co-dissolution conditions. The wt % of solids was determined by moisture analysis. The wt % of the CCA is measured relative to the mass of the solids in the emulsion.

TABLE 1A

| | Resin | MEK | CCA | EtOH |
|---|---|---|---|---|
| Sample | (g) | (g) | (g) | (g) |
| Emulsion 1 | 100 | 120 | 3 | 10 |
| Emulsion 2 | 100 | 175 | 3 | 20 |
| Emulsion 3 | 100 | 175 | 3 | 30 |
| Emulsion 4 | 81 | 165 | 3 | 32 |

TABLE 1B

| | D10 | D50 | D95 | width | Solids | | CCA |
|---|---|---|---|---|---|---|---|
| Sample | (nm) | (nm) | (nm) | (nm) | (wt %) | pH | (wt %) |
| Emulsion 1 | 73.2 | 519 | 1739 | ND | ND | ND | ND |
| Emulsion 2 | 76.1 | 139.2 | 334 | 147.1 | 36.8 | 8.21 | 2.6 |
| Emulsion 3 | 85.9 | 123.5 | 193.2 | 67.4 | 31.7 | 8.41 | 2.6 |
| Emulsion 4 | 118.8 | 278.8 | 627 | 300 | 19.78 | 7.98 | 3 |

### Example 2: Aqueous Emulsion Synthesis by Combining Charge Control Agent with Previously Emulsified Anionic Polyester

An anionic polyester emulsion (40 wt % polymer solids) was mixed with an alcohol solution of benzyltributylammonium naphthalenesulfonate (6 wt % dissolved solids) and deionized water. The mixture was heated at 65° C. for 30 minutes. The solvent was removed by vacuum distillation (600 mm Hg) at 50° C. After cooling to room temperature, the mass of the remaining mixture was determined.

Table 2A shows the amounts of components used in forming the final aqueous emulsions obtained starting from previously emulsified anionic polyester. In Tables 2A and 2B, resin refers to the anionic polyester and CCA is the charge control agent. Table 2B shows particle size distribution and other data of the final aqueous emulsions obtained starting from previously emulsified anionic polyester. Corresponding data for the starting anionic polyester emulsion is also presented for comparison in Table 2B. As shown in Table 2B, incorporating the charge control agent within the aqueous emulsions did not significantly impact the particle size distribution of the emulsified polymer particles. Solids in the final emulsion were determined by moisture analysis.

TABLE 2A

| | Amount | | | | | Final | |
|---|---|---|---|---|---|---|---|
| | of 40 | | Amount | | Amount | Mass | |
| | wt % | | of 6 wt % | | of | After | Solids in |
| | Resin | Amount | CCA | Amount | Added | Vacuum | Final |
| | Emulsion | of Resin | Solution | of CCA | Water | Distil- | Emulsion |
| Sample | (g) | (g) | (g) | (g) | (g) | lation (g) | (wt %) |
| Emulsion 5 | 625 | 250 | 125 | 7.50 | 382.5 | 601.85 | 43.39 |
| Emulsion 6 | 250 | 100 | 41.84 | 2.51 | 91.11 | 210.40 | 48.70 |
| Emulsion 7 | 250 | 100 | 58.35 | 3.50 | 95.95 | 228.72 | 41.49 |

TABLE 2B

| | CCA in | | | | | | CCA in |
|---|---|---|---|---|---|---|---|
| | emulsion | Mᵥ | D10 | D50 | D95 | Width | particles |
| Sample | (wt %) | (nm) | (nm) | (nm) | (nm) | (nm) | (wt %) |
| Emulsion 5 | 3.0 | 185.2 | 134.3 | 180.6 | 241.6 | 82.8 | 2.7 |
| Emulsion 6 | 2.5 | 188.2 | 132.2 | 181.1 | 252.9 | 91.6 | 2.4 |
| Emulsion 7 | 3.5 | 195.3 | 125.6 | 182.0 | 329.0 | 185.2 | 3.2 |
| Anionic Polyester | — | 189.3 | 139.9 | 185.2 | 243.7 | 80.5 | — |
| Emulsion Control | | | | | | | |

General Emulsion Aggregation-Coalescence Toner Production Procedure. In a 2 L reactor, about 291 g of amorphous polyester emulsion (40 wt % polymer solids), 42.5 g of crystalline polyester emulsion (40 wt % polymer solids), 89.8 g yellow pigment dispersion (18 wt % pigment particles, PY-74 pigment), and 76.8 g wax dispersion (30 wt % wax solids) were combined with about 715 g deionized water. The crystalline polyester emulsion was prepared as described in U.S. Patent Application Publication 2011/0177444. The pH of the mixture was adjusted to about 4.2 using 0.3 M nitric acid solution. Next, 4.48 g of aluminum sulfate solution (27.85 wt % aluminum sulfate) was added into the mixture and homogenized over a period of 5 minutes. The reactor was then heated at about 48° C. with stirring.

A shell polyester emulsion containing benzyltributyammonium naphthalenesulfonate (charge control agent), prepared according to Example 1 or Example 2 above, was adjusted to a pH to 3.5 with nitric acid. Once the D50 of the core emulsion reached a particle size of 5.2 μm to 5.4 μm, the shell polyester emulsion was added using a metered pump. Aggregation was continued until the D50 reached about 6.0 μm. The reaction was stopped by adding aqueous sodium hydroxide solution and sodium ethylenediaminetetraacetic acid (EDTA) chelating agent to increase the pH to about 7.5 to about 7.7.

The mixture was then heated at 85° C. for coalescence. Aqueous sodium hydroxide and a sodium dodecylbenzenesulfonate surfactant solution were slowly added to increase the pH to a range of 7.8 to 8.2. The mixture was then held at the coalescence temperature while monitoring circularity. 0.3 wt % to 0.5 wt. % ammonium persulfate solution was added after 30 minutes of coalescence, and the pH was further lowered by the addition of a 1% acetic acid solution to increase the rate of coalescence. Once a circularity of about 0.970 was achieved, the mixture was passed through a heat exchanger to quickly lower the temperature to below the glass transition temperature of the toner particles. The toner particles were collected by filtration, washed, and dried using typical methods to produce dry toner particles. The dried toner particles were then mixed with external additive materials using convention blending techniques to form finished toner compositions.

### Example 3: Toner Particles Prepared Using Aqueous Emulsions of Example 1

Toner particles were prepared using the general procedure and Emulsions 3 and 4 of Example 1. Table 3 shows properties of the resulting toner particles relative to a comparative negatively chargeable toner.

TABLE 3

| | | CCA in | | | Corrected |
|---|---|---|---|---|---|
| | | Toner | | | Tribo |
| | Shell | Particles | D50 | | Charge |
| Sample | Emulsion | (wt %) | (μm) | Circularity | (μcoulomb/g) |
| Toner | Emulsion | 0.89 | 5.72 | 0.972 | 20.14 |
| Particles 1 | 3 | | | | |
| Toner | Emulsion | 0.84 | 6.52 | 0.968 | 14.12 |
| Particles 2 | 4 | | | | |
| Comparative | — | — | 5.82 | 0.971 | −15.48 |
| Negatively | | | | | |
| Chargeable | | | | | |
| Toner | | | | | |

### Example 4: Toner Particles Prepared Using Aqueous Emulsions of Example 2

Toner particles were prepared using the general procedure and Emulsions 5-7 of Example 2. Table 4 shows properties of the resulting toner particles relative to a comparative negatively chargeable toner.

TABLE 4

| | | CCA in | | | Corrected |
|---|---|---|---|---|---|
| | | Toner | | | Tribo |
| | Shell | Particles | D50 | | Charge |
| Sample | Emulsion | (wt %) | (μm) | Circularity | (μcoulomb/g) |
| Toner | Emulsion | 0.79 | 6.27 | 0.972 | 17.47 |
| Particles 3 | 7 | | | | |
| Toner | Emulsion | 0.72 | 6.07 | 0.971 | 15.49 |
| Particles 4 | 5 | | | | |
| Toner | Emulsion | 0.58 | 5.93 | 0.973 | 21.40 |
| Particles 5 | 6 | | | | |
| Comparative | — | — | 5.82 | 0.971 | −15.48 |
| Negatively | | | | | |
| Chargeable | | | | | |
| Toner | | | | | |

Table 5 shows the triboelectric charges of various finished toner compositions formulated using the toner particles from Table 4. The triboelectric charge of a commercial positively chargeable toner composition is also shown for comparison.

TABLE 5

| | | Corrected |
|---|---|---|
| | | Tribo |
| | Toner | Charge |
| Sample | Particles | (μcoulomb/g) |
| Comparative | — | 11.94 |
| Positively | | |
| Chargeable Toner | | |
| Toner 3 | Toner | 12.83 |
| | Particles 3 | |
| Toner 4 | Toner | 12.99 |
| | Particles 4 | |
| Toner 5 | Toner | 15.82 |
| | Particles 5 | |

As shown, the experimental toner samples displayed greater positive chargeability than did the comparative positively chargeable toner.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

The invention claimed is:

1. An aqueous emulsion comprising:
a plurality of microparticles dispersed in an aqueous fluid, the microparticles comprising an anionic polymer; and
at least one charge control agent located upon at least a portion of an outer surface of at least a portion of the microparticles, the at least one charge control agent being positively chargeable.

2. The aqueous emulsion of claim 1, wherein the at least one charge control agent comprises a quaternary ammonium cation and a sulfonate anion.

3. The aqueous emulsion of claim 1, wherein the anionic polymer comprises an anionic polyester.

4. A method comprising:
providing a combined emulsion comprising a plurality of microparticles dispersed in a continuous phase and at least one charge control agent dissolved in the continuous phase, the microparticles comprising an anionic polymer and the at least one charge control agent being positively chargeable;
wherein the continuous phase comprises water and at least one water-miscible organic solvent; and
removing at least a portion of the at least one water-miscible organic solvent from the combined emulsion to produce the aqueous emulsion of claim 1.

5. The method of claim 4, wherein the at least one charge control agent comprises a quaternary ammonium cation and a sulfonate anion.

6. The method of claim 4, wherein the anionic polymer comprises an anionic polyester.

7. The method of claim 4, wherein providing the combined emulsion comprises:
dissolving the anionic polymer in a first organic solvent to form a first solution;
dissolving the at least one charge control agent in the water-miscible organic solvent to form a second solution;
combining the first solution and the second solution to form a combined solution; and
homogenizing the combined solution with a base to produce the combined emulsion.

8. The method of claim 7, wherein the first organic solvent comprises methyl ethyl ketone.

9. The method of claim 7, wherein the first organic solvent is also removed before, during, and/or after removing the at least one water-miscible organic solvent.

10. The method of claim 4, wherein providing the combined emulsion comprises:
providing a precursor aqueous emulsion comprising the plurality of microparticles dispersed in an aqueous phase; and
combining the precursor emulsion with a solution comprising the at least one charge control agent dissolved in the water-miscible organic solvent to produce the combined emulsion.

11. The method of claim 4, wherein the at least one water-miscible organic solvent is removed by distillation.

12. The method of claim 11, wherein the at least one water-miscible organic solvent is removed at a sub-atmospheric pressure.

13. A composition comprising:
a plurality of toner particles comprising an anionic polymer, the toner particles comprising a core surrounded by a shell; and
at least one charge control agent localized within the shell of the toner particles, the at least one charge control agent being positively chargeable.

14. The composition of claim 13, wherein the at least one charge control agent comprises a quaternary ammonium cation and a sulfonate anion.

15. The composition of claim 13, wherein the anionic polymer comprises an anionic polyester.

16. The composition of claim 13, further comprising:
one or more internal additives located within the toner particles.

17. The composition of claim 13, further comprising:
one or more external additives.

18. A method comprising:
aggregating microparticles within a first aqueous emulsion below a glass transition temperature of the microparticles to form aggregated microparticles, the microparticles comprising an anionic polymer;
contacting the aggregated microparticles with the aqueous emulsion of claim 1 and then heating the aggregated microparticles above the glass transition temperature;
maintaining the aggregated microparticles above the glass transition temperature until the aggregated microparticles have coalesced into molten microparticles having a desired shape and/or morphology; and
once molten microparticles having the desired shape and/or morphology have formed, cooling the molten microparticles below the glass transition temperature to form toner particles comprising a core surrounded by a shell;
wherein the at least one charge control agent is localized within the shell of the toner particles.

19. The method of claim 1, wherein the at least one charge control agent comprises a quaternary ammonium cation and a sulfonate anion.

20. The method of claim 19, wherein the anionic polymer comprises an anionic polyester.
